(19) United States
(12) Patent Application Publication
(10) Pub. No.: US 2022/0318820 A1
(43) Pub. Date: Oct. 6, 2022

(54) LOTTERY ASSEMBLY AND PACKAGING DEVICE

(71) Applicant: Shenzhen Ficus Technology Holdings Limited, Shenzhen (CN)

(72) Inventors: Theresa WOO, Shenzhen (CN); Ting CHAN, Shenzhen (CN); King Shan Karen CHAN, Shenzhen (CN); King On Anthony CHAN, Shenzhen (CN); Emma Sophia Chan KAST, Shenzhen (CN); Ka Chun Kevin CHEUK, Shenzhen (CN)

(73) Assignee: Shenzhen Ficus Technology Holdings Limited, Shenzhen (CN)

(21) Appl. No.: 17/708,835

(22) Filed: Mar. 30, 2022

(30) Foreign Application Priority Data
Mar. 31, 2021 (CN) 202120677878.4

(51) Int. Cl. G06Q 30/00

(52) U.S. Cl. CPC G06Q 30/0185; G06K 19/06028

(57) ABSTRACT

A lottery assembly and a packaging device are provided. The lottery assembly includes a lottery portion and a code portion, the lottery portion includes a lottery area, and the code portion is provided with a code area on a side surface thereof. The code portion is separated from the lottery portion, and first information included in the code area is in correspondence with second information included in the lottery area. The packaging device includes a housing and the above lottery assembly, and the housing defines an accommodation space for accommodating a commodity. The lottery portion is located in the accommodation space, and at least part of the code portion is provided outside the housing to expose the code area.

### CROSS-REFERENCE TO RELATED APPLICATIONS

The present application claims priority to Chinese Utility Model Application No. 202120677878.4, filed on Mar. 31, 2021, the content of which is incorporated herein by reference in its entirety.

### TECHNICAL FIELD

Embodiments of the present disclosure relate to the field of commodity package, and in particular to a lottery assembly and a packaging device having the lottery assembly.

### BACKGROUND

Manufacturers are paying increasing attention to anti-counterfeiting of commodities, especially high-end commodities. Various anti-counterfeiting measures such as barcode and laser trademark are applied at the commodities, but the commodities are still constantly counterfeited. It is difficult for consumer s to identify the authenticity of anti-counterfeiting measures, and some of the anti-counterfeiting measures are easily counterfeited. If the manufacturer cannot find the counterfeit products in the market in real time, the counterfeiter will have the opportunity to counterfeit commodities.

A solution has been proposed to provide an anti-counterfeiting lottery on an outer package of a commodity. However, the anti-counterfeiting lottery may cover an obvious area of the outer package so as to obscure the information displayed on the outer package. Further, the existing outer package of the commodity may be required to be modified in order to provide the anti-counterfeiting lottery.

### SUMMARY

In An aspect of embodiments of the present disclosure, a lottery assembly is provided. The lottery assembly includes a lottery portion including a lottery area and a code portion provided with a code area on a side surface thereof. The code portion is arranged to be separated from the lottery portion, and the code area includes first information which is in a correspondence with second information included in the lottery area.

Another aspect of embodiments of the present disclosure provides a packaging device. The packaging device includes a housing configured to define an accommodation space for accommodating a commodity and the above lottery assembly. The lottery portion is arranged in the accommodation space, and at least part of the code portion is provided outside the housing to expose the code area.

### BRIEF DESCRIPTION OF DRAWINGS

These and other features and advantages of various embodiments of the present disclosure can be understood by the following description and the drawings, in which the same reference numerals refer to the same components.

FIG. 1 is a schematic diagram of a lottery assembly according to an exemplary embodiment of the present disclosure, in which a lottery portion and a code portion are connected with each other by a connecting portion;

FIG. 2 is a schematic diagram of a packaging device according to an exemplary embodiment of the present disclosure, in which a code portion is shown;

FIG. 3 is a schematic diagram of a packaging device according to an exemplary embodiment of the present disclosure, in which a code portion, a lottery portion and a connecting portion are shown, and the code portion and the lottery portion are physically connected with each other by the connecting portion;

FIG. 4 is a schematic diagram of a lottery assembly according to another exemplary embodiment of the present disclosure, in which a lottery portion and a code portion are not physically connected with each other; and

FIG. 5 is a schematic diagram of a packaging device according to an exemplary embodiment of the present disclosure, in which a code portion and a lottery portion are shown, and there is no connecting portion to physically connect the code portion and the lottery portion.

### DESCRIPTION OF EMBODIMENTS

The technical solutions of the present disclosure are further specifically described below with reference to the embodiments and the drawings. The following description of the embodiments of the present disclosure with reference to the drawings is intended to explain the general concept of the present disclosure, and should not be construed as a limitation on the present disclosure.

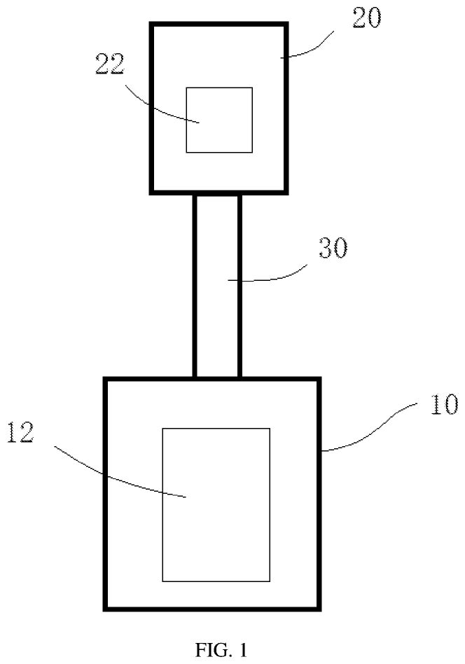

FIG. 1 is a schematic diagram of a lottery assembly according to an exemplary embodiment of the present disclosure.

As shown in FIG. 1, the lottery assembly includes a lottery portion 10, a code portion 20, and a connecting portion 30. The connecting portion 30 is connected between the lottery portion 10 and the code portion 20. A code area 22 is provided on a side surface of the code portion 20. The code portion 20 is separated from the lottery portion 10. The code area 22 includes first information that is in correspondence with second information included in the lottery portion 10.

In the embodiment of the present disclosure, the lottery portion is a lottery of which authenticity is identifiable. For example, the lottery may be a lottery approved and issued by a relevant state institution, and the authenticity of the lottery can be verified by the consumer through inquiry. In embodiments of the present disclosure, the form of the lottery portion is not limited as long as the lottery portion has independent identification information (corresponding to the lottery portion) and can be redeemed.

In embodiments of the present disclosure, the lottery portion 10 includes at least one of a scratch area, a lottery barcode area and a reward-redeeming barcode area, which is an effective area or a lottery area 12. For example, the lottery portion 10 includes a scratch area, a lottery barcode area, and a reward-redeeming barcode area. The lottery barcode area can be regarded as the identification information of the lottery, and the lottery and the lottery barcode are in one-to-one correspondence. The reward-redeeming barcode area is used during the reward redemption. If the reward-redeeming barcode area has been scratched, it means that the lottery has been redeemed or the lottery cannot be used for the reward redemption.

In an embodiment of the present disclosure, the lottery may employ a barcode. It should be noted that the lottery may be identified (including reward-redeeming identification) through numbers or other identification methods.

In embodiments of the present disclosure, the first information of the code area 22 has a correspondence with the second information of the lottery area of the lottery portion 10. That is, there is a correspondence between the first information of the code area 22 and the identification information (for example, information corresponding to a lottery number) of the lottery area.

In embodiments of the present disclosure, the code area of the code portion 20 is provided with a barcode, a quick response (QR) code, or other code that can be scanned or identified, all of which fall within the scope of the present disclosure. In an embodiment, the code area includes a QR code.

The dimension of the code portion 20 is not limited in the present disclosure, as long as it is convenient for a user or consumer to acquire the first information in the code area 22.

As shown in FIG. 1, the connecting portion 30 is strip-shaped. The connecting portion 30 physically connects the code portion 20 and the lottery portion 10, and the lottery portion 10 corresponds to the code portion 20.

In an embodiment, after the code portion and the lottery portion are formed separately, the code portion and the lottery portion are connected with each other by the connecting portion 30. In this case, the connecting portion 30, the code portion and the lottery portion are connected integrally with each other. That is, if the connecting portion 30 is disconnected from the code portion or the lottery portion, the connecting portion cannot be reused to connect the code portion and the lottery portion as the previous connection. In addition, before the connecting portion connects the code portion 20 and the lottery portion 10, the connecting portion 30 may be formed integrally with the code portion or the lottery portion, or the connecting portion 30 may be formed independently of the code portion 20 and the lottery portion 10. These embodiments all fall within the scope of the present disclosure.

If the code portion and the lottery portion are formed independently of each other, the connecting portion 30 may be made of a material different from that of the lottery portion or the code portion.

In at least one embodiment, the connecting portion 30 is a connecting cord or other strip.

In an embodiment, the code portion 20, the lottery portion 10 and the connecting portion 30 are formed integrally. In this case, the aforementioned connecting steps are not applicable.

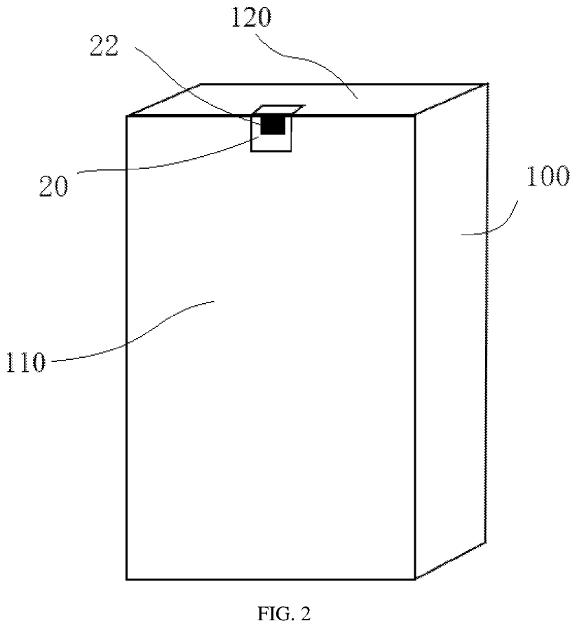

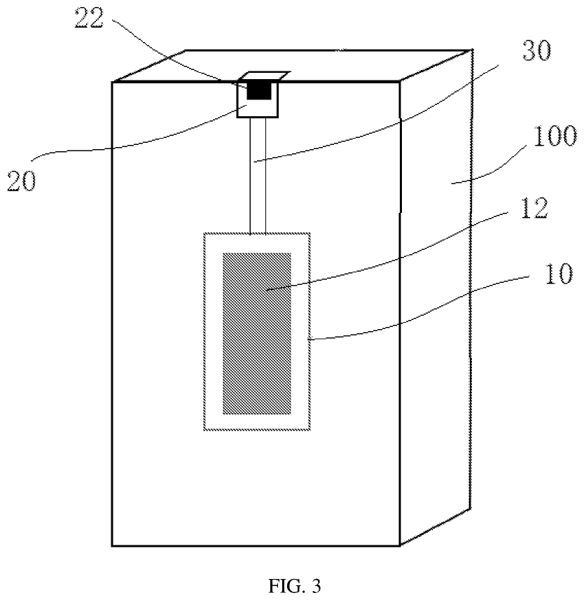

In embodiments of the present disclosure, a length of the connecting portion 30 is determined based on actual requirements, provided that at least part of the code portion 20 is arranged outside a housing as shown in FIG. 2 and the lottery portion 10 is arranged inside the housing (as shown in FIG. 3). In the present disclosure, there is no special requirement for a width of the connecting portion 30, as long as the connecting portion connects the lottery portion 10 and the code portion 20 conveniently such that the lottery portion 10 is arranged inside the housing and at least part of the code portion 20 is arranged outside the housing.

In embodiments of the present disclosure, except for the code area 22 corresponding to the lottery portion, the code portion 20 is further provided with an anti-counterfeiting mark. The anti-counterfeiting mark may be separated from the code area 22, or may overlap with the code area 22.

In an embodiment of the present disclosure, the code portion 20 is provided with the code area 22 or the code area 22 and the anti-counterfeiting mark at a side surface thereof, and is provided with an adhesive at another side surface to adhere the code portion 20 on a package.

In view of the above description, there is provided a lottery assembly including the lottery portion and the code portion. The code portion is provided with the code area at a side surface. The code portion is separated from the lottery portion. The first information of the code area corresponds to the second information of the lottery portion.

FIG. 2 is a schematic diagram of a packaging device according to an exemplary embodiment of the present disclosure, in which a code portion 20 is shown. FIG. 3 is a schematic diagram of a packaging device according to an exemplary embodiment of the present disclosure, in which a code portion 20, a lottery portion 10 and a connecting portion 30 are shown, and the code portion 20 and the lottery portion 10 are physically connected with each other by the connecting portion 30.

As shown in FIGS. 2 and 3, the packaging device includes a housing 100. The housing 100 defines an accommodation space for accommodating a commodity. The housing 100 is provided with an unpacking portion. In an embodiment shown in FIG. 2, the housing 100 may be torn from a ridgeline, which corresponds to the unpacking portion. In an embodiment, the ridgeline is processed by weakening a strength thereof. In other words, the unpacking portion includes an unpacking line, which is configured to be split or broken based on relative movement of portions of the housing located at two sides of the unpacking line. The unpacking portion is configured to be broken to take the commodity out of the accommodation space.

As shown in FIGS. 2 and 3, the code portion 20 covers at least part of the unpacking portion.

It should be noted that the unpacking portion is not limited to the ridgeline shown in FIG. 2. In an embodiment, if the housing is required to be disassembled from an end, the unpacking portion is located on an end surface of the housing. In this case, the unpacking portion may be an unpacking line provided on the end surface. For example, a part of the end surface of the housing is depressed and broken from the unpacking line by pressing down the vicinity of the unpacking line.

It should also be noted that the unpacking portion is not limited to the ridgeline or unpacking line. The unpacking portion may be a surface. In an embodiment, an end surface of the housing is the unpacking portion. In other words, the commodity may be taken out of the housing by breaking the end surface of the housing.

In addition, in an embodiment of the present disclosure, a housing 100 for packaging is provided with a sidewall 110, a bottom wall (not shown in the figures), and a cover 120. The cover 120 is configured to be opened to take the commodity out of the accommodation space. The code portion 20 covers a part of a gap between the cover 120 and the sidewall 110.

In an embodiment, for example, the housing is an outer packaging box of a wine bottle, and a top end surface of the housing above the wine bottle can be closed. In this case, after the wine bottle is placed into the accommodation space of the housing, the lottery portion 10 of the lottery assembly shown in FIG. 1 is also placed into the accommodation space, and the code portion 20 of the lottery assembly is located outside the housing. As shown in FIGS. 2 and 3, after the top end surface is closed, the code portion 20 covers a part of a gap between the top end surface and the sidewall of the housing.

In an embodiment of the present disclosure, before a lottery portion of each lottery assembly is placed into an outer package of a commodity, relevant information is entered into the code area of the code portion 20, such as a QR code area. The relevant information includes a serial number of the lottery in the lottery portion (which, for example, corresponds to the identification information of the lottery) and commodity information of the commodity with the lottery assembly. The user or consumer can scan the QR code area through the WeChat scan function on a mobile phone to enter an online verification platform to verify the authenticity of the commodity, check the commodity information and the lottery information in the lottery assembly, and redeem reward through the lottery. That is, the user or the consumer can scan the code area of the code portion 20 to verify the authenticity of the product, check the commodity information and the lottery information in the anti-counterfeiting lottery assembly, and redeem reward through the lottery. The user or consumer can also participate in a marketing service provided by the online verification platform. That is, the first information in the code area may include extended service information related to the commodity, which corresponds to service information on the online verification platform.

In embodiments of the present disclosure, the code portion 20 may not have an adhesive function, and is merely required to be connected to the outside of the housing via the connecting portion 30.

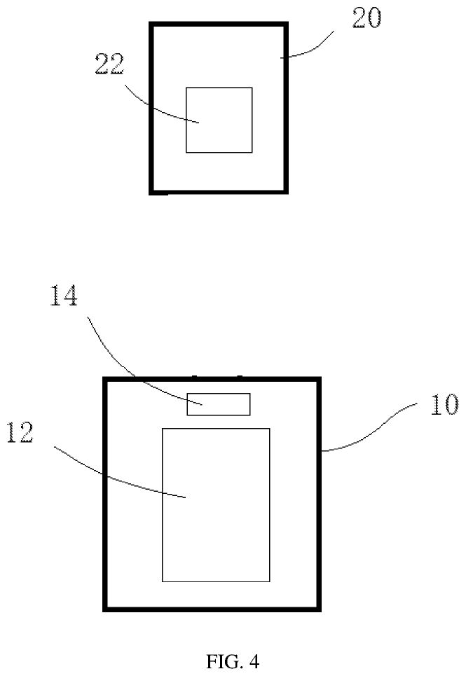

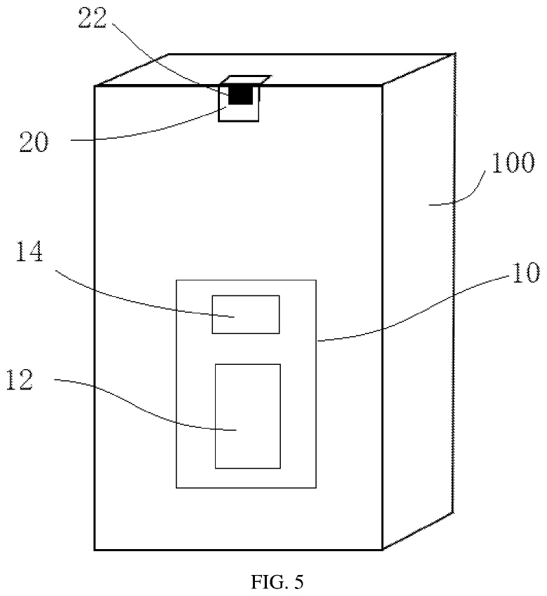

In the above embodiments, as shown in FIGS. 1 and 3, the code portion 20 and the lottery portion 10 are connected with each other by the connecting portion 30, but the present disclosure is not limited herein. In other embodiments, the connecting portion 30 may not be provided. FIG. 4 is a schematic diagram of a lottery assembly according to another exemplary embodiment of the present disclosure, in which a lottery portion and a code portion are not physically connected with each other. FIG. 5 is a schematic diagram of a packaging device according to an exemplary embodiment of the present disclosure, in which a code portion and a lottery portion are shown and there is no connecting portion to physically connect the code portion and the lottery portion.

As shown in FIG. 4, the code portion 20 and the lottery portion 10 are not physically connected with each other. In this case, however, the lottery portion 10 is provided with a special area as a lottery code area 14. The information of the lottery code area 14 of the lottery portion is in correspondence with the first information of the code area 22 of the code portion 20. Meanwhile, as described above, the first information of the code area 22 of the code portion 20 is in a correspondence with the identification information of the lottery area.

In view of the above description, there is further provided a packaging device. The packaging device includes a housing and the above lottery assembly. The housing defines the accommodation space for accommodating a commodity. The lottery portion is provided in the accommodation space, and at least part of the code portion is provided outside the housing to expose the code area.

Although the embodiments of the present disclosure are described, those of ordinary skill in the art may make various changes to these embodiments without departing from the principle and spirit of the present disclosure, and the scope of the present disclosure is defined by the appended claims and equivalents thereof.

What is claimed is:

1. A lottery assembly, comprising:
a lottery portion comprising a lottery area; and
a code portion provided with a code area on a side surface thereof,
wherein the code portion is arranged to be separated from the lottery portion, and the code area comprises first information in a correspondence with second information comprised in the lottery area.

2. The lottery assembly according to claim 1, further comprising:
a connecting portion configured to connect the lottery portion and the code portion.

3. The lottery assembly according to claim 2, wherein the connecting portion is a connecting strip or a connecting cord.

4. The lottery assembly according to claim 2, wherein the connecting portion is connected integrally to the lottery portion and the code portion; or
the connecting portion, the lottery portion and the code portion are formed integrally.

5. The lottery assembly according to claim 1, wherein the code area comprises a quick response code or a barcode.

6. The lottery assembly according to claim 1, wherein the code portion comprises an anti-counterfeiting area or an anti-counterfeiting mark.

7. The lottery assembly according to claim 6, wherein the anti-counterfeiting area or anti-counterfeiting mark is arranged to be separated from the code area; or
the anti-counterfeiting area or anti-counterfeiting mark overlaps with at least part of the code area.

8. The lottery assembly according to claim 1, wherein an adhesive layer is provided on another side surface of the code portion.

9. The lottery assembly according to claim 1, wherein the first information of the code area comprises lottery information, and the lottery information is in correspondence with lottery verification information on an online verification platform.

10. The lottery assembly according to claim 1, wherein the first information of the code area further comprises commodity information, and the commodity information is in correspondence with commodity verification information on an online verification platform; and/or
the first information of the code area comprises extended service information related to an commodity on an online verification platform, and the extended service information is in correspondence with platform service information on the online verification platform.

11. A packaging device, comprising:
a housing configured to define an accommodation space for accommodating a commodity; and
a lottery assembly comprising a lottery portion and a code portion, the lottery portion comprising a lottery area, and the code portion being provided with a code area on a side surface thereof,
wherein the code portion is arranged to be separated from the lottery portion, and the code area comprises first information in a correspondence with second information comprised in the lottery area;
wherein the lottery portion is arranged in the accommodation space; and
wherein at least part of the code portion is provided outside the housing to expose the code area on a side surface of the code portion.

12. The packaging device according to claim 11, wherein an adhesive layer is provided on another side surface of the code portion; and
at least part of the another side surface of the code portion is adhered to an outer side of the housing.

13. The packaging device according to claim 12, wherein the housing is provided with an unpacking portion, and the unpacking portion is configured to be broken to take the commodity out of the accommodation space; and
the code portion covers at least part of the unpacking portion.

14. The packaging device according to claim 13, wherein the unpacking portion comprises an unpacking line, and the unpacking line is configured to be split or broken by relative movement of portions of the housing located at two sides of the unpacking line; or
the unpacking portion comprises an unpacking surface formed by an end surface of the housing.

15. The packaging device according to claim 12, wherein the housing is provided with a sidewall, a bottom wall, and a cover, and the cover is configured to be opened to take the commodity out of the accommodation space; and
the code portion covers a part of a gap between the cover and the sidewall.

16. The packaging device according to claim 11, wherein the first information of the code area is configured to be in correspondence with information on an online platform.

17. The packaging device according to claim 16, wherein the online platform comprises an online verification platform; and
the first information of the code area is configured to be in correspondence with lottery verification information on the online verification platform.

18. The packaging device according to claim 16, wherein the online platform comprises an online verification platform; and
the first information of the code area comprises commodity information of the commodity, and the commodity information is in correspondence with commodity verification information on the online verification platform; and/or the first information of the code area comprises extended service information related to the commodity on the online verification platform, and the extended service information is in correspondence with platform service information on the online verification platform.
